(19) United States
(12) Patent Application Publication
(10) Pub. No.: US 2004/0111274 A1
(43) Pub. Date: Jun. 10, 2004

(54) System and method for deploying a virtual laboratory environment for a business

(75) Inventors: James Kelly O'Rourke, Hudson, OH (US); Jeffry Joseph Batie, Oregon City, OR (US)

Correspondence Address: Brouse McDowell, 500 First National Tower, Akron, OH, 44308-1471, US

(73) Assignee: TAK Industrial Corporation

(21) Appl. No.: 10/047,084

(22) Filed: Jan. 14, 2002

(51) Int. Cl. G06F 17/60

(52) U.S. Cl. 705/1

(57) ABSTRACT

The present invention is a system and method using information system technology which provides end-use customers and the sponsors of private labeled laboratory testing analysis programs the ability to utilize any laboratory or number of laboratories (commercial or internal), or on-site testing equipment concurrently and/or in succession and to receive all of the services and benefits of each individual source. In addition, the end-use customers, as well as the suppliers, benefit from the ability to combine all source data to from a comprehensive and uninterrupted analysis program over a long period of time, improvement of each individual sourced program through optional enforcement of specific data integrity parameters, creating a powerful data repository, and use internet technology to improve the ease of use of each and all sourced programs.

### TECHNICAL FIELD OF THE INVENTION

This invention relates in general to the field of information technology systems, and more particularly to the application of information technology systems to methods for use in managing and providing laboratory and testing equipment output data relative to end-user customers in industrial markets.

### BACKGROUND OF THE INVENTION

The present invention is directed to a system and method of managing data from testing laboratories and testing equipment utilizing analysis. More particularly, it is directed to a method of managing data from two or more different or independent analytical sources, either concurrently or in succession. The present invention is very applicable to businesses utilizing oil analysis. The present invention will be presented in the context of a business utilizing oil analysis, but as will be come apparent, it will be useful for other business system environments where it is necessary to combine dissimilar data from different or independent analytical sources.

Usually, dissimilar data will be generated where data is not normally shared. This happens where the data is generated by independent or different analytical sources. Systems exist where the data comes from different analytical locations or from different testing equipment. In order to generate data from these locations that can be readily combined, a system is established beforehand so that each location generates data in the same format or in ways that the data can be combined. But, there are analytical sources or testing equipment which are not normally set up to facilitate pooling of data. These are independent analytical sources because they generate dissimilar data. For the purpose of this application, the term “independent analytical sources” is intended to mean at least two analytical sources, including laboratories and testing equipment, that generate dissimilar data, and not simply data from different locations or different analytical equipment or sources.

Oil analysis, as an industrial maintenance tool, was initiated by the major railroads in the 1940's as an internal preventative maintenance practice for the locomotive engines that were a major capital asset. Generally, a 2-ounce to 5-ounce sample is drawn from the sump of a working lubricant environment (engine, gear box, transmission, hydraulic system, etc.) and it is analyzed using laboratory equipment under prescribed testing methods of chemical or physical analysis. Like a blood test for a human, laboratory analysis of the sample of used oil can indicate “health” of the oil in the unit and “health” of the equipment, which the oil is lubricating.

Commercial laboratories, internal laboratories, or on-site test equipment can perform the analysis. Commercial oil analysis normally involves independent laboratories testing of used oil for a fee and producing quantitative test results (i.e., parts per million of metals found in the used oil that would indicate bearing wear) and qualitative recommendations (i.e., change oil or overhaul engine) for the customer. Internal company laboratories, i.e., laboratories owned by major oil companies and/or other industrial corporations, also perform oil analysis, as well as function as the research and development arms of the company for internal purposes. On-site testing is done at the location of the equipment or machinery being monitored, when necessary or as a convenience, and uses the analytical devices on-site which replicate at least part of the testing available at a full-service oil analysis laboratory.

Each of these laboratories and on-site testing equipment generate and maintain the test data or “history” for each lubricated unit, whether it is a vehicle, tractor, plant equipment, vessel, rail engine, or the like for that customer. For oil analysis to be effective, historical trending of laboratory test results is required, as opposed to the snapshot view of one test. That is, how many parts per million of some material found three months ago, six months ago, and nine months ago is much more valuable than the absolute number or snapshot of one test. Further, each laboratory retains the historical data in their unique format for each unit of the customer in their database.

As part of a comprehensive oil analysis service program, all Major Oil companies, and many other companies, including engine manufacturers such as Detroit Diesel, Cummins, John Deere, encourage oil analysis by the end-user customers via outsourced oil testing by commercial laboratories. This service includes providing test kits where the laboratory “brands” the test kit materials and paperwork with the Major Oil company or engine manufacturer logo and image. While most of this oil analysis service is offered to the Major Oil and Engine Manufacturer distributors and/or end-user customers, it is also common for the Major Oil Company or Engine Manufacturer to use their own laboratory testing as a “free” service to market segments such as large national account customers. The Private Labeled program done by commercial laboratories is usually offered to a broader customer base to keep the costs as low as possible.

Also, there has always been a “perception” dilemma with oil companies and equipment manufacturers trying to market an internal, company-managed lubricant analysis program for monitoring and making recommendations on their own oil or equipment. Inherently, this has set up the scenario of the “fox watching the henhouse” so to speak. Hence, commercial laboratories have filled the need for an “independent, non-biased” source of quality oil analysis services for major oil companies. However, as with any vendor/customer relationship, oil companies and their distributor/marketer networks have formed preferences of which labs to use, sometimes according to geographic location, personal relationships, laboratory capabilities, pricing and various other factors. This has created a situation of having to periodically change, or select various commercial laboratories to suit the distributors or customers of the particular oil company preferences or, in some cases, their dissatisfaction with a particular lab. The changing of labs is a time consuming and costly proposition because of data histories, new report formats, new personnel and procedures to deal with and manage.

Oil analytical processes are known. For example, U.S. Pat. No. 5,412,581, to J. E. Tackett, teaches a method for measuring physical properties of hydrocarbons by an absorption spectrum analytical technique using a reference hydrocarbon.

The problem presented is that a customer or Private Labeled oil analysis program cannot easily switch laboratories without great expense and losing value on the overall program because the data may not be available (laboratory will not provide) and/or the usability is limited by a new laboratory due to differing data schemes of their information technology environment. Further, laboratories regularly go through business changes in personnel, equipment and capability, and accept jobs from a variety of sources. Laboratory profile changes and workloads may result in analysis not being done on a timely or accurate basis, causing the need for the use of alternative laboratories.

### SUMMARY OF THE INVENTION

The present invention has resulted from the discovery that information system technology can be used in a system and method for providing management of laboratory and on-site testing from independent analytical sources and for the management of a comprehensive oil analysis program. The present invention offers end-use customers and sponsors of private labeled analysis programs the ability and flexibility to utilize any laboratory or number of laboratories (commercial or internal), or on-site testing equipment, concurrently and/or in succession while receiving all of the services and benefits of each individual source. In addition, the end-use customers, as well as the suppliers, benefit from:

1) The ability to combine all source data to from a comprehensive and uninterrupted analysis program over a long period of time

2) Improvement of each individual sourced program through optional enforcement of specific data integrity parameters, creating a powerful data repository

3) Internet technology to improve the ease of use of each and all sourced programs as an inexpensive communication medium which is available “24×7” (i.e., 24 hours a day and seven days a week).

### BRIEF DESCRIPTION OF THE DRAWINGS

A more complete understanding of the present invention and the advantages thereof may be acquired by referring to the following description taken in conjunction with the accompanying drawings.

FIG. 1 is a block diagram showing an overview of the environment and connectivity regarding access into the virtual laboratory processing engine and databases for end-use customers through oil company web sites, distributor web sites or “program” web sites; and various laboratories or on-site testing equipment.

FIG. 2 is a block diagram showing a topographical representation of the entities in the business process and the general data flow between the entities via the Internet.

FIG. 3 is a flow diagram showing a business process and data transfers in which a commercial laboratory is the source point of the testing data.

FIG. 4 is a flow diagram showing a business process and data transfers in which an internal oil company laboratory is the source point of the testing data.

FIGS. 5A though 5D are basic data model schema of the virtual laboratory data repository of a system in accordance with the present invention.

### DETAILED DESCRIPTION OF THE INVENTION

A system and method utilizing an information technology system for providing analysis and management of laboratory and on-site testing data, relating to a business using analysis from independent analytical sources, as a stand-alone process and entity is provided. The system and process includes an external communication layer for display and interaction with laboratory test data and user-centric profile data; a virtual laboratory processing engine for business logic execution for transactional processing via business rule management of data; a database structure specifying data format and retaining data history; and an external communication layer directing data-transfer protocol with independent laboratories or on-site testing equipment.

The virtual laboratory processing engine is a computing means, such as a computer, which is programmed to store and interact with data communicated across the layered environment to allow end users to display, manipulate, input and manage data independent of reliance of original laboratory or on-site testing equipment data source. The virtual laboratory processing engine allows original laboratory or on-site testing equipment data to be enhanced by the complete environment for user accessibility. The system and process are very useful, for example, for a business using oil analysis, such as where the concern is lubrication of a vehicle or a piece of machinery or equipment.

The method of the present invention offers customers and the sponsors of Private Labeled oil analysis programs, such as Major Oil Companies and Equipment Manufacturers, the ability to utilize any laboratory or number of laboratories (commercial or internal), or on-site testing equipment concurrently and/or in succession to receive all of the services and benefits of each individual source along with the ability to combine all source data to from a comprehensive and uninterrupted oil analysis program over a long period of time, improve each individual sourced program through optional enforcement of specific data integrity parameters, thereby creating a powerful data repository, and using internet technology to improve the ease of use of each and all sourced programs.

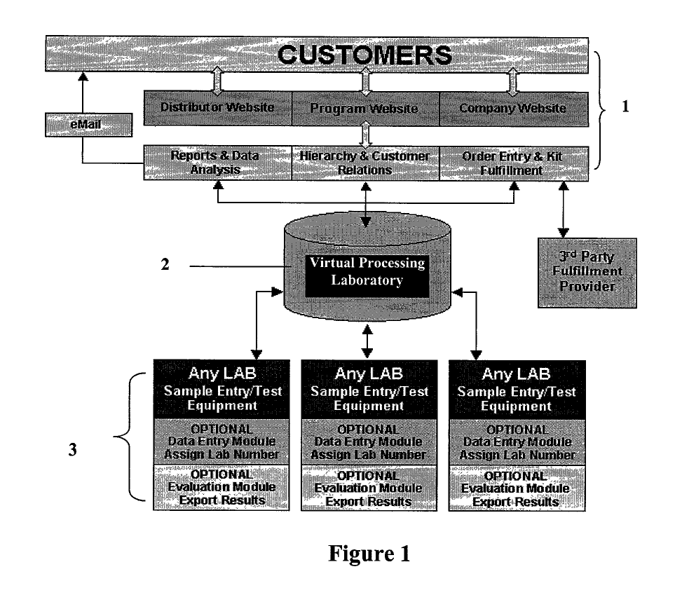

As can be seen from FIG. 1, which provides an overview, the system and process includes an external communication layer 1 for display and interaction with customers via user-centric profile data; a virtual laboratory processing engine 2 for business logic execution for transactional processing via business rule management of data, which includes a database structure specifying data format and retaining data history; and an external communication layer 3 directing data-transfer protocol with independent laboratories or on-site testing equipment.

The virtual laboratory processing engine interacts with data communicated across the layered environment to allow end users to display, manipulate, input and manage data independent of reliance of original laboratory or on-site testing equipment data source. The virtual laboratory processing engine allows original laboratory or on-site testing equipment data to be enhanced by the complete environment for user accessibility. The virtual laboratory processing engine is a data processing and computing means or computer, which has been programmed to retrieve data from remote locations, store the data, and perform logic and algorithmic based analysis of a database for calculating and comparing the performance of oil brand products in the sets and subsets for a vehicle or piece of machinery or equipment relative to the performance of other oil products in the sets and subsets of a vehicle or piece of machinery or equipment. The engine is also capable of analyzing the variable of usage of the oil by the product and/or equipment, and generate workflow recommendations, actions and outcomes.

The analysis programs employed in the engine will automatically notify the oil companies via the Internet when oil sampling is not accomplished at prescribed intervals per the manufacturer guidelines, when abnormal calculations or trends are established for a vehicle or piece of machinery or equipment indicating corrective action to be taken by the end user of said vehicles or pieces of machinery or equipment, provide workflow process comments which are entered into said data repository and forwarded to other parties via the Internet or become communication to direct action items. The program also will capture workflow process comments in the data repository to retain a historical recap of corrective action recommendations and subsequent actions. This will allow for alerts, notices, and tracking of actions of end-user customers relative to their equipment to maximize the value of the oil analysis program, regardless of laboratory data source.

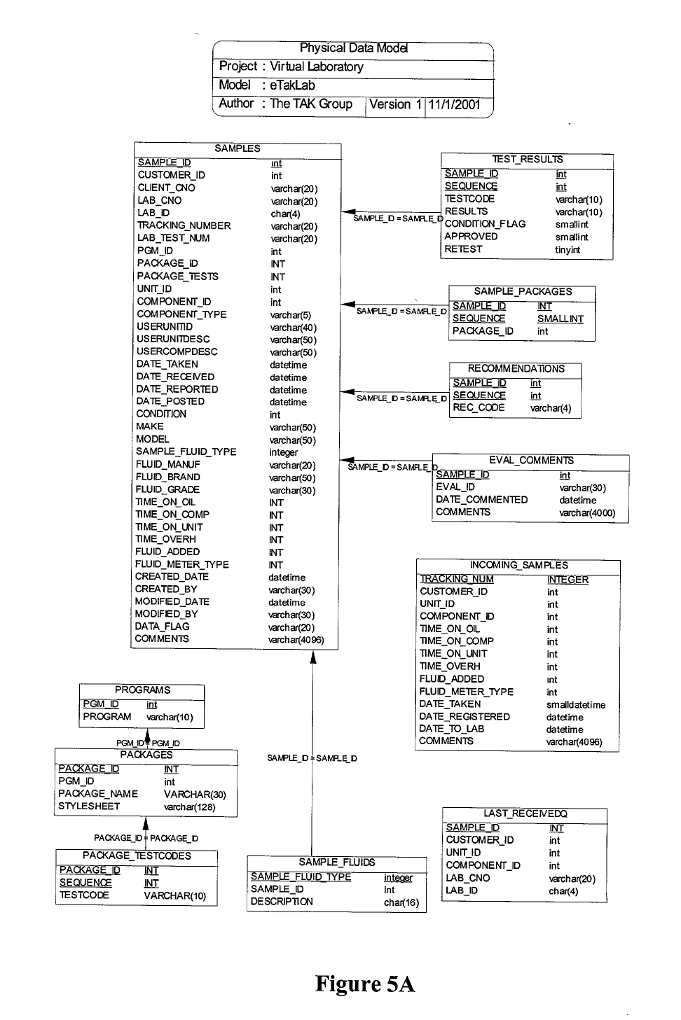

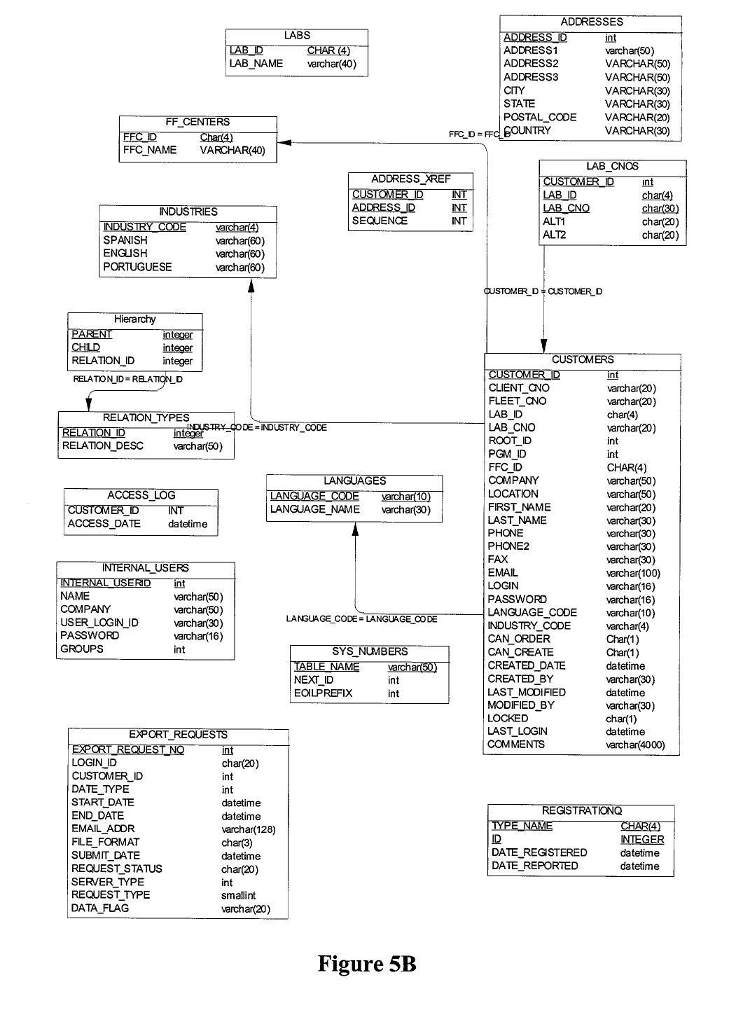

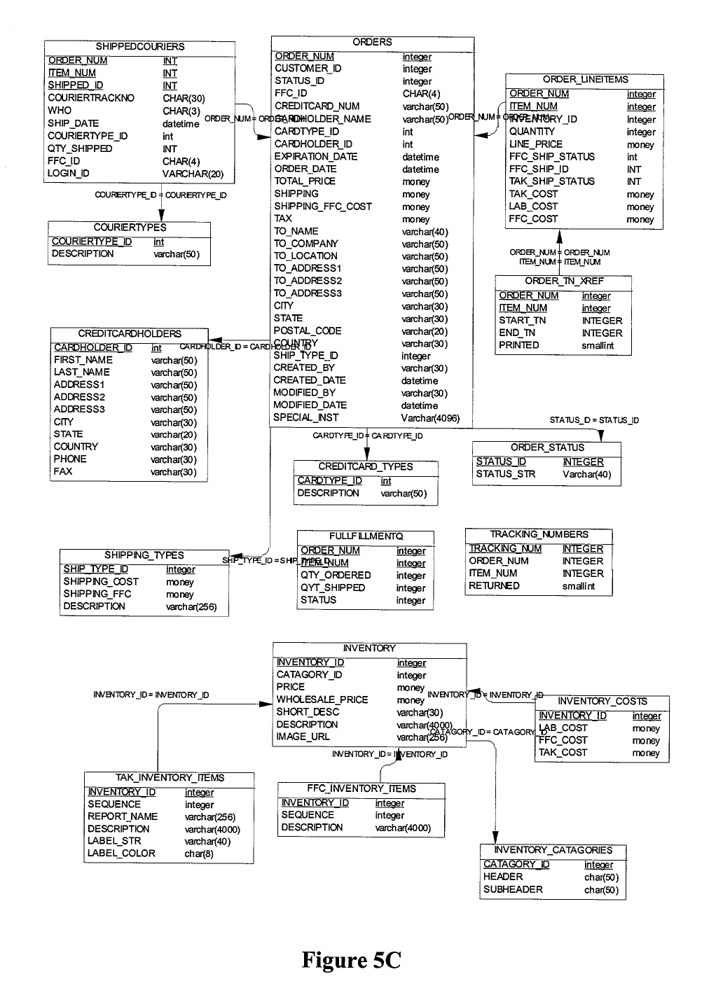

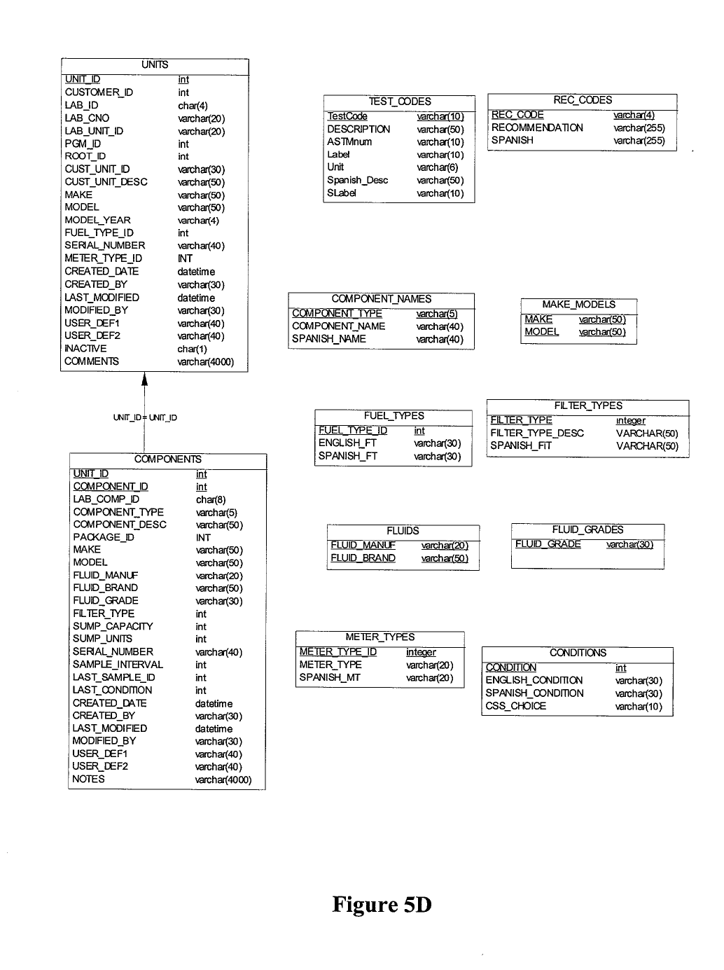

The virtual laboratory processing engine also is associated with means for displaying the results, as well as means for communicating and retrieving data via the Internet. The range of data display is illustrated by FIGS. 5A through 5D, which is an example of the scope of what can be displayed. This is one aspect of the invention that could be customized since different customers have different needs and it is not necessary to display all of the information that is possible.

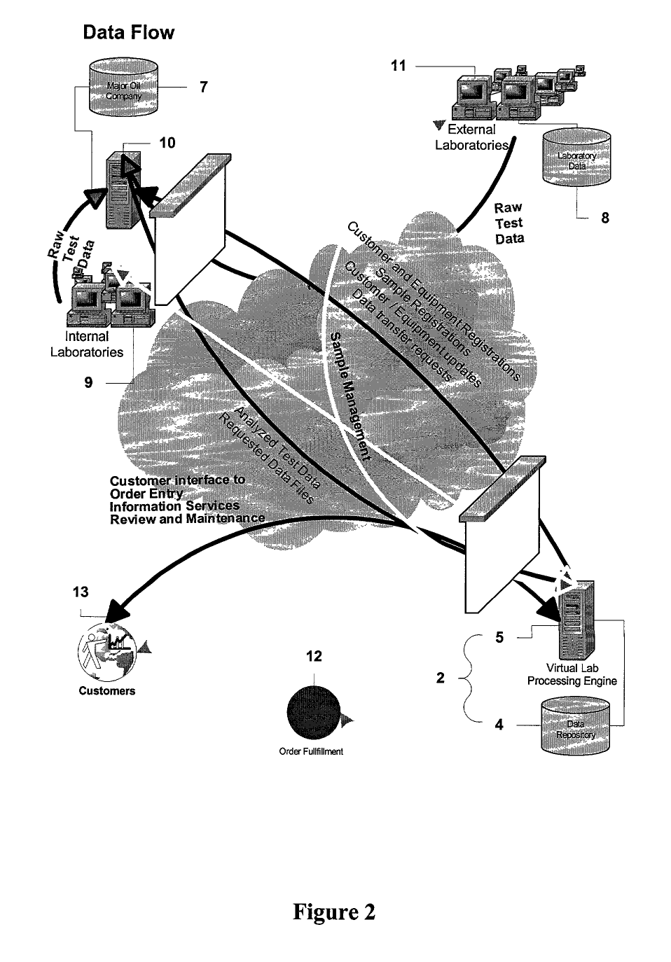

FIG. 2 illustrates the flow of data between the internal laboratories at major oil companies, engine manufacturers, etc. 9 and external commercial laboratories 11 to the virtual laboratory processing engine 5 and the data repository 4, as well as the flow of data between the virtual processing laboratory 2 to the order fulfillment center 12 used by oil companies, distributors etc. to provide test kits and supplies to end-use customers 13. As noted earlier, the virtual processing laboratory 2 functions via a programmed computer 5. The virtual laboratory 2 retrieves raw test data from remote locations such as a major oil company laboratory 7 and the external laboratory databases 8. The major oil company data is generated at internal laboratories 9 via personal computers and the data generated is gathered in a central computer 10. The external laboratories 11 also generate data via personal computers but normally store this data in personal computer's database 8. The virtual laboratory 2 retrieves the data from the oil company central computer 10 or it could be obtained directly from the internal laboratories personal computers 9, as well as from the external laboratories personal computers 11. The virtual laboratory processing engine 5 also receives order data flows and provides test result data flows to the end-use customers 13 and to the order fulfillment center 12. The fulfillment center 12 provides the test kits and supplies to end-use customers 13. The processing of the data flows by virtual processing laboratory 2 allows for feedback of information as well as measuring the performance of the order fulfillment program 12 so that sampling programs are maintained on a timely and consistent basis.

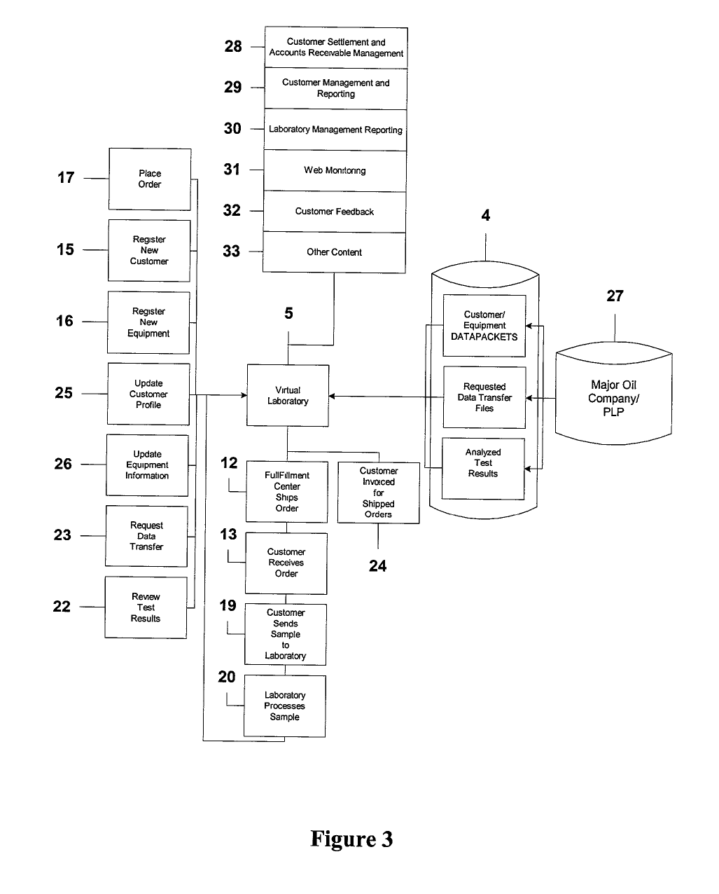

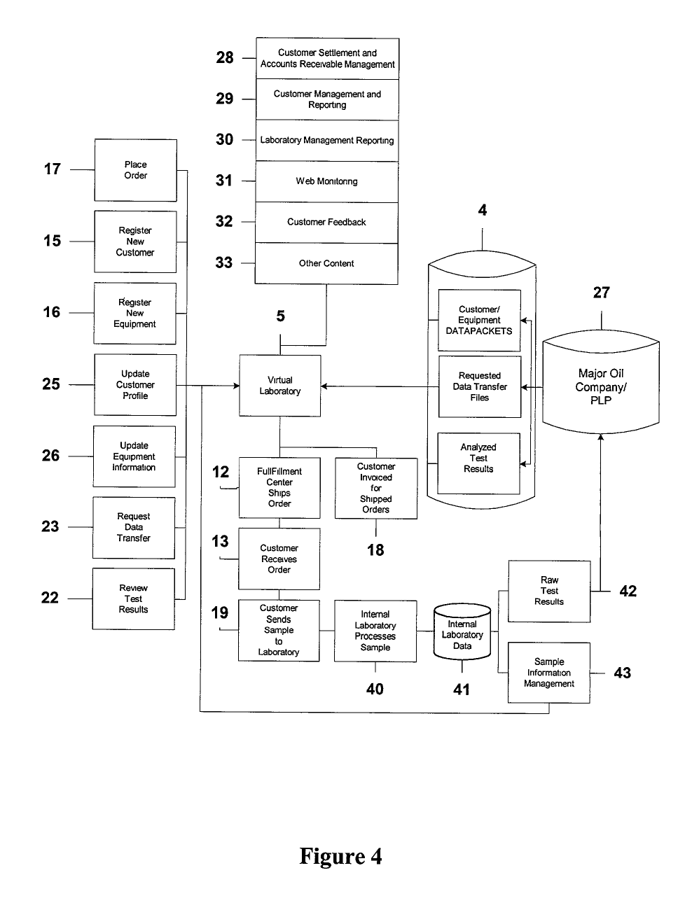

With the present invention, the benefits are realized by being able to import external commercial, internal or remote on-site laboratory data into a “data universe” that is specific to that customer of the private labeled oil analysis program and then utilize the data in every element of the business process. Two examples will be presented, and these are illustrated in FIGS. 3 and 4. FIG. 3 illustrates, via a block diagram, a business process and data transfers where a commercial laboratory is the source point of the test data. FIG. 4 illustrates, via a block diagram, a business process and data transfers where an internal oil company laboratory is the source point of the test data.

The method of the present invention, can be illustrated by the following example, which is illustrated in FIG. 3. The illustration begins at the point a registered end user (Private Label sponsor personnel, distributors, end-use customers, laboratory and fulfillment center personnel) has entered the virtual laboratory environment through one of a variety of secure internet channels such as a direct program web site, Private Label internet portal, distributor web sites and/or specific major customer sites. Each end user will be registered via phone, fax or on-line through another end user. The method is detailed by the following steps:

Step 1: After entering the virtual laboratory environment, the end user will select one or more of the following processes:

Step 1a—Place Order: The order process may be done on-line at 17 as a self-help process or via fax or phone via a customer support process (not shown). The orders may be for test kits and supplies, or for analysis to be done when the sample arrives at the laboratory. At the time of order, the end-user customer's profile stored at 4 will dictate how the fulfillment center 12 will complete the order, including the proper forms for the laboratory or on-site testing equipment at 20 the end-user customer wishes to use as the testing source for that particular order, which may be different than previous or future orders.

Step 1b—Register New Users: Registered users may register additional users through the on-line registration process at 15 as a self-help process or via fax or phone via a customer support process (not shown).

Step 1c—Register New Equipment: Equipment, units, components, etc. (as defined by the end-user customer or Private Label program nomenclature) will be registered on-line at 16 as a self-help process or via fax or phone as a customer support process, or by the laboratory upon the receipt of samples (not shown).

Step 1d—Update User Profile: Registered users may update the profile stored in the user/equipment database at 4 through the on-line registration process 25 as a self-help process or via fax or phone as a customer support process (not shown). This process enables the end user to maintain their profiles in one location for use by any and/or all of the virtual laboratory processes, such as order fulfillment 12, customer invoicing 24, laboratory testing 20, etc.

Step 1e—Update Equipment Information: Registered users may update the equipment information stored in the user/equipment database 4 through the on-line registration process 26 as a self-help process or via fax or phone as a customer support process (not shown). This process enables the end-use customer to maintain their equipment profiles in one location for use by any and/or all of the virtual laboratory processes, such as the external laboratory process 20.

Step 1e—Request Data Transfer: Sample data and histories will be available for e-mailing via a request to transfer data at 23 in several different electronic formats including DBF, CSV and XML. Data will be easily downloadable into the end-user customer's own Computerized Maintenance Management System (CMMS) software for further manipulation and evaluation by the end-user customer.

Step 1f—Review Test Results: The review test results process 22 enables the end user to print the report locally or have the report e-mailed directly from a view page. All web site users will have the ability to view the most current test report and the complete history for the equipment maintained by the user/equipment database 4. Private Label Sponsors may design specific reports that are appropriate to their specific oil analysis program. Additionally, the user can set an automatic e-mail function for posting of test results directly to the customer coincident with the completion of the laboratory testing process 20. This option will not require the user to log into the site.

Step 2: Depending on the process selected in Step 1, the virtual laboratory processing engine 5 will update the virtual laboratory database repository 4, provide data transfer to from the end user or send an order to the Fulfillment center 12 to ship a test kit and required material (tubing, valves, pumps, etc.) to the customer, the Private Label Sponsor representative or distributor to deliver to the end-user customer. The order process also sets up the testing parameters in the database 4. These test parameters will be available to the laboratories at 20 to complete the testing requirements which can be unique to each customer.

Step 3—Fulfillment Center Ships Order: The fulfillment center 12 receives the order and ships requested items to the customer, the Private Label Sponsor representative or distributor. The fulfillment center also notifies the virtual laboratory processing engine 5 the order has shipped which initiates the customer invoicing process at 24.

The invoice to the customer for the service is dependent on the specific business rules of each program. The service may be invoiced at the time of kit or supply orders are completed at 24, or for a time parameter set to accumulate tested samples, complimentary, or a combination of the three.

Step 4—Customer Receives Order: The end-user customer receives the sample test kit and required material and fills the sample bottle (or other testing container included in the sample kit) with used oil (or other material to be tested). The end-user customer identifies the sample container by completing a blank, preprinted, or partially preprinted label that came with the supplies, or may print a label locally off the virtual laboratory Internet site to attach on the sample bottle. The labels may be bar-coded with as much information as known at the time of label printing.

Step 5—Customer Sends Sample to Laboratory: The end-user customer sends the sample to the external laboratory (Private Label Sponsor lab or independent commercial lab) for testing at 19. The end user may “set-up” the analysis on-line prior to sending the sample to the laboratory.

Step 6—Laboratory Processes Sample: The laboratory will access the virtual laboratory database 4 (or local integrated Laboratory Information Management System, which is not shown) for sample information (including bar-code reading), or will input the information required to complete the sample testing at 20. The laboratory processes the sample and generates the “raw data” test results for the sample per ASTM, Modified ASTM, Private Label Sponsor—proprietary or other testing methods. The “raw data” feeds will be transmitted to the virtual laboratory processing engine 5 for final evaluation. Alternatively, commercial laboratories may be required to evaluate samples and make recommendations to be published in the virtual laboratory environment dependent on the wishes of the end-user customer or business model of the Private Labeled oil analysis program. Based on the customers parameters established at 22, the Virtual Laboratory Processing Engine will send the results directly to the end user, notify the customer the results are available or maintain the results for a customer initiated review.

Step 7—Private Label Sponsor ERP Integration (Optional): The integration with the ERP system of a Private Label Sponsor 27 will be predicated on the specific business rules of each program. This “back office” integration with the virtual laboratory environment will be accomplished via XML or other file integration tools.

Step 8—Additional Virtual Laboratory Processes: The Virtual Laboratory environment will also perform the following processes:

Step 8a—Customer Settlement and Accounts Receivable Management: The customer may complete e-payment for the testing service at the time of ordering at 17 or at the time of accepting test results at 22, or will be billed for the service subject to business rules of the particular program at 28. Outsourced Accounts Receivable Management can be accomplished via the virtual laboratory environment where ERP integration is not desired.

Step 8b—Customer Management Reporting: The virtual laboratory environment will store general and customized reports at 29 for the end user accessible through their recognized log in. Example reports could include Periodic Testing Recap, Missed Units Report, Specific Location Testing, Critical Results Recap and numerous other reports.

Step 8c—Laboratory Management Reporting: Outsourced commercial laboratories will be monitored for performance, such as lab turn-around time, with results available for Private Label Sponsor employees involved with the management of a particular oil analysis program at 30.

Step 8d—Web Monitoring: Statistical data and metrics will be maintained on usage of the virtual laboratory web pages and published for Private Label Sponsor employees involved with the management of a particular program or the environment overall at 31.

Step 8e—Customer Feedback: Capability will exist for the user to provide feedback via the virtual laboratory web pages relative to the oil analysis program in total and/or the Internet features and functionality at 32. The method and practice of responding to customer feedback will be determined, following guidelines prescribed by Private Label Sponsor 27.

Step 8f—Other Content: The site will contain content ranging from “how-to” guides for oil sampling to the value proposition of a dedicated oil analysis program to Private Label Sponsor brand marketing to “closed-loop” customer feedback of positive testimonials and case studies at 33.

FIG. 4 illustrates the method of the present invention where an internal oil company laboratory is the source point of the test data. Steps 1-5 and 7-8 are the same as FIG. 3, with the exception of the billing portion of Step 3 which will often involve a heavily discounted of “gratis” charge to the customer 18 based on the customer's new lubricant purchasing volume per the oil company's financial records, as opposed to a commercial testing fee 24 as depicted in FIG. 3.

For FIG. 4, Step 6 has been modified from FIG. 3 to illustrate that the laboratory doing the processing 40 will be an owned and controlled operation of the major oil company. The data may be included as a sub-set of all of the internal laboratory data 41 including oil company data for testing programs that are not part of this business model. In the case of the internal laboratory testing, the data structure will be incorporated into the established internal sample information management system 43 and generate raw test results 44 that can be incorporated in the entire internal laboratory testing population.

Thus, unique business model of enabling both processes described in FIGS. 3 and 4 under the common architecture of FIGS. 1, 2, and 5 offers the end-user customers and Private Label oil analysis program sponsors, and their distributors, the ability to utilize any combination of laboratories and/or on-site testing equipment to gain all of the benefits of oil analysis without the heavy risks and switching costs of the predominant business model. Connecting the disparate players and processes is the key to the improved method.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method of using an information technology system to managing the data of a business using independent analytical sources, where the analysis is done by at least two independent analytical sources, comprising the steps of:
a. identifying at least one end-user customer by collecting data and inputting the data about said end-user customer into a computing means;
b. identifying at least one vehicle, piece of machinery, or equipment for which data is being collected by collecting data and inputting the data into said computing means;
c. obtaining sample test data from at least two independent analytical sources for said at least one vehicle, piece of machinery, or equipment of end-user customers;
d. combining and organizing the data into a common data repository under one data model schema; and
e. distributing and reporting the test results of at least the two said data sources in a common and integrated format to at least one user of the system.

2. The method of claim 1 wherein the analysis is done on petroleum-based products.

3. The method of claim 1 wherein the analysis is done on lubricant products.

4. The method of claim 1 wherein the data is collected via the Internet.

5. The method of claim 1 wherein the analysis is oil analysis.

6. The method of claim 1 wherein the data is combined and organized using a computing means for retrieving data from said analytical sources, storing said data, and capable of logic- and algorithmic-based analysis of a database

7. A method utilizing an information technology system for managing analysis programs provided for multiple end-user customers comprising the steps of:
a. identifying all end-user customers as unique and specific entities by collecting and inputting data about said end-user customers in a computing means;
b. allowing said end-user customers certain and specific rights to Internet functionality features and the data repository of said end-user customers;
c. identifying all vehicles or pieces of machinery or equipment as unique and specific units of the data repository of said end-user customers;
d. combining and organizing the data repository of said end-user customers such that all data is sorted, accumulated, aggregated, trended, and managed in relation to the unique and specific entities of said end-user customers and said vehicles of pieces of machinery or equipment; and
e. handling for said end-user customers one or more business transactions selected from the group consisting of:
i. customer registration,
ii. equipment registration,
iii. ordering test kits, supplies or laboratory testing analysis,
iv. reporting laboratory analysis results,
v. generating invoices for test kit and supply orders or analysis services,
vi. management of accounts receivable, and
vii. collecting payments and disbursing revenue-sharing benefits or supplier payments.

8. The method of claim 7 further including offering joint private labeling for corporation oil analysis programs for the corporation, its distributors or end-user customers comprising the steps of:
a. accomplishing the identifying, combining, and organizing of said data via Graphical User Interfaces presented to users over the Internet with branded pages of said corporations, distributors and/or end-user customers; and
b. organizing the end-user customer data under a hierarchical relationship with said corporation, distributors and/or end-user customers.

9. A method utilizing an information technology system for managing corporation oil analysis programs including allowing for alerts, notices, and tracking of actions of end-user customers relative to their equipment to maximize the value of the oil analysis program, regardless of laboratory data source, comprising the steps of:
a. performing the method steps of claim 7;
b. automatically notifying said oil companies via the Internet when oil sampling is not accomplished at prescribed intervals per the manufacturer guidelines of said machinery or equipment;
c. automatic notification via the Internet is made when abnormal calculations or trends are established for a vehicle or piece of machinery or equipment indicating corrective action to be taken by the end user of said vehicles or pieces of machinery or equipment;
d. providing workflow process comments which are entered into said data repository and forwarded to other parties via Internet or become communication to direct action items; and
e. capturing said workflow process comments in said data repository to retain a historical recap of corrective action recommendations and subsequent actions.

10. A system for managing large corporation oil analysis programs comprising:
a. at least one first means for storing archival analysis data at a first remote location;
b. at least one second means for storing archival analysis data at a second remote location;
c. an information technology system computing means for retrieving data from said first and second remote locations, storing said data, and capable of logic- and algorithmic-based analysis of a database;
d. processor means for calculating and comparing the performance of oil brand products in the sets and subsets for a vehicle or piece of machinery or equipment relative to the performance of other oil products in the sets and subsets of a vehicle or piece of machinery or equipment, the variable of usage of the oil product and/or equipment, and the workflow recommendations, actions and outcomes; and
e. means for displaying the results.

11. The system of claim 10 wherein the archival analysis data is retrieved from said first and second remote locations via the Internet.

12. A system for managing the data of a business using laboratory testing analysis, where the analysis is done by at least two analytical sources, comprising:
a. at least first means for storing analytical data at a first remote storage unit,
b. at least a second means for storing analytical data at a second remote storage unit,
c. processor means for retrieving data from one of said plurality of analytical data storing means.

13. The system of claim 12 wherein the analysis is done on petroleum-based products.

14. The system of claim 12 wherein the data is oil analysis and the business utilizes at least one vehicle or piece of equipment or machinery.

15. The system of claim 12 wherein the analysis is done on lubricant products.
